(19) United States
(12) Patent Application Publication
(10) Pub. No.: US 2026/0217877 A1
(43) Pub. Date: Jul. 30, 2026

(54) CATALYST SYSTEM FOR POLYMERIZATION OF ETHYLENE

(71) Applicant: SABIC GLOBAL TECHNOLOGIES B.V., Bergen op Zoom (NL)

(72) Inventors: Coen HENDRIKSEN, Eindhoven (NL); Robert Lap Key CHAN, Best (NL); Vikas Shripat KSHIRSAGAR, Maastricht (NL); Jens PANITZKY, Dorsten (DE)

(21) Appl. No.: 19/142,462

(22) PCT Filed: Dec. 5, 2023
(86) PCT No.: PCT/EP2023/084405

§ 371 Date: Jun. 23, 2025

(30) Foreign Application Priority Data
Dec. 23, 2022 (EP) 22216461.8

(51) Int. Cl. C08F 10/02

(52) U.S. Cl. CPC C08F 10/02

(57) ABSTRACT

Catalyst system for the production of polyethylene comprising: I) the reaction product obtained by reacting, preferably in a reactor vessel a) a hydrocarbon solution comprising: i) a magnesium-containing compound selected from an organic oxygen-containing magnesium compound and/or a halogen-containing magnesium compound; and ii) an organic oxygen-containing titanium compound wherein the molar ratio of magnesium:titanium is lower than 3:1; and b) an organo aluminium halide having the formula AlRnX3-n in which R is a hydrocarbon moiety containing 1-10 carbon atoms, X is a halogen and 0<n<3; wherein the molar ratio of supplied organo aluminium halide I)b) to supplied titanium in I)a) in the preparation of I) is in the range of 1 to 12; and wherein the average particle size distribution (PSD) of the catalyst particles is in the range of 0.8 to 1.6 and wherein PSD is defined as PSD=D90−D10)/D50.

### CROSS REFERENCE TO RELATED APPLICATIONS

This application is a National Stage application of International Application No. PCT/EP2023/084405, filed Dec. 5, 2023, which claims the benefit of European Application No. 22216461.8, filed Dec. 23, 2022, both of which are incorporated by reference in their entirety herein.

### BACKGROUND

The present invention relates to a catalyst system for the production of polyethylene and a process for the production of polyethylene using said catalyst system.

Polyethylene can be produced in a gas phase, a solution or a slurry process. In the ethylene slurry polymerization process, diluents such as hexane or isobutane are used to dissolve the ethylene monomer, comonomers and hydrogen to polymerize the monomer(s) in the presence of a catalyst system. Following polymerization, the polyethylene product formed is present as slurry of solid polyethylene particles suspended in the liquid medium, as the polyethylene polymer particles are insoluble or substantially insoluble in the diluent.

In the polyethylene polymerization process a good polymer particle morphology is required for smooth operation of the plant. Polymer powder morphology encompasses, for example, uniformity of polymer particle size and shape, good flowability and high bulk density.

The bulk density of the polymer powder refers to the mass of the powder per unit of volume. This is an important parameter because the obtained powder has to be stored and to be transported.

A higher bulk density may for example decrease clogging at its transportation and it is possible to increase the storable amount per unit volume. By increasing the bulk density, the weight of the polyethylene per unit volume present in a polymerization vessel will be increased and the concentration of the polyethylene powder in the polymerization vessel can be enhanced.

Moreover the formation of small polymer particles (polymer particles <100 μm), also called fines, caused by fragmentation of the polymer particles need to be overcome. In particular dryer and decanter performance suffer from sheeting and fouling caused by small polymer particles. This fouling leads for example to a decrease in the efficiency of heat exchangers. In addition, the equipment needs to be cleaned more often, which is expensive and leads to production losses. Likewise, the particles may deposit on sensors causing issues in controlling the polymerization process or deposition may lead to plugging of pipelines.

Meanwhile it is now widely accepted that the morphology of polymer particles is mainly determined by the morphology of the catalyst particles through the replication phenomenon. Thus there is a need to improve catalyst particle morphology. At the same time it is desired that the catalyst shows a high activity. On top of that it is required that the catalyst system can be synthesized in an easy and simple way on commercial scale.

It is therefore object of the invention to provide a catalyst system which shows a high catalyst activity, is easy to prepare and results in polyethylene powder particles displaying a high powder bulk density, uniformity of particle size, suitable morphology and good flowability.

### SUMMARY

Surprisingly it has been found, that this object is been achieved at least in part by the catalyst system according to the invention for the production of polyethylene which comprises
I) the reaction product obtained by reacting, preferably in a reactor vessel
   a) a hydrocarbon solution comprising:
      i) a magnesium-containing compound selected from an organic oxygen-containing magnesium compound and/or a halogen-containing magnesium compound; and
      ii) an organic oxygen-containing titanium compound
         wherein the molar ratio of magnesium:titanium is lower than 3:1;
and
   b) an organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and wherein the average particle size distribution (PSD) of the catalyst particles is in the range of 0.8 to 1.6 and wherein PSD is defined as PSD=(D₉₀−D₁₀)/D₅₀ and D₁₀, D₉₀ and D₅₀ are measured by laser diffraction as described in this description, preferably wherein the hydrocarbon solution and the organo aluminium halide are supplied to the reactor vessel simultaneously.

### BRIEF DESCRIPTION OF THE FIGURES

FIG. 1 shows laser diffraction PSD curves of homopolymerization of PE powder from Ex.1-4;

FIG. 2 shows an image analysis of Ex. 2 and Ex. 4 Comparative;

FIG. 3 shows a representative SEM image of PE powder from Ex. 2;

FIG. 4 shows a representative SEM image of PE powder from Ex. 4 Comp.;

FIG. 5. laser diffraction PSD curve of Ex. 7, Inv. Cat. 2;

FIG. 6 shows a SEM image of Ex.7 Cat 2 of the PE copolymer;

FIG. 7 shows a SEM image of Ex. 8 Cat Comp. 1 of the PE copolymer; and

FIG. 8 shows light scattering image analysis PSD curves of Ex. 7 and Ex. 8 Comp. of the PE polymer.

### DETAILED DESCRIPTION

Preferably the catalyst system according to the invention for the production of polyethylene which comprises
I) the reaction product obtained by reacting, in a reactor vessel
   a) a hydrocarbon solution comprising:
      i) a magnesium-containing compound selected from an organic oxygen-containing magnesium compound and/or a halogen-containing magnesium compound; and
      ii) an organic oxygen-containing titanium compound
         wherein the molar ratio of magnesium:titanium is lower than 3:1;
      and
   b) an organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution (PSD) of the catalyst particles is in the range of 0.8 to 1.6 and wherein PSD is defined as PSD=(D₉₀−D₁₀)/D₅₀ and D₁₀, D₉₀ and D₅₀ are measured by laser diffraction as described in this description, wherein the hydrocarbon solution and the organo aluminium halide are supplied to the reactor vessel simultaneously.

The average Average Particle Size Distribution (PSD) may be defined as PSD=(D90−D10)/D50 wherein D90 is the percentile value that indicate the size below which 90% of all particles are found, D10 is the percentile value that indicate the size below which 10% of all particles are found, D50 is the percentile value that indicate the size below which 50% of all particles are found, and wherein the particle size is determined using laser diffraction.
In an aspect of the invention, the invention relates to the catalyst system for the production of polyethylene obtained by or obtainable by a process comprising the steps of:
   a) providing a hydrocarbon solution comprising:
      i) a magnesium-containing compound selected from an organic oxygen-containing magnesium compound; and/or a halogen-containing magnesium compound; and
      ii) an organic oxygen-containing titanium compound I)a);
wherein the molar ratio of magnesium:titanium is lower than 3:1;
   b) providing an organo aluminium halide I)b) having the formula AlRₙX₃₋ₙ in which R is a hydrocarbon moiety containing 1-10 carbon atoms, X is a halogen and 0<n<3;
   c) introducing the hydrocarbon solution and the organo aluminium halide simultaneously into a reactor vessel; and
   d) obtaining the catalyst system comprising a reaction product (I) obtained by the reaction of the hydrocarbon solution and the organo aluminium halide;
wherein the molar ratio of supplied organo aluminium halide I)b) to supplied titanium I)a) in the preparation of (I) is in the range of 1 to 12; and
wherein the average particle size distribution (PSD) of the catalyst particles contained in the catalyst system is in the range of 0.8 to 1.6 and wherein PSD is defined as PSD=(D₉₀−D₁₀)/D₅₀ and D₁₀, D₉₀ and D₅₀ are measured by laser diffraction as described in this description.

The catalyst system according to the invention leads to polymer powder particles showing a good flowability. This ensures that the powder can be dosed easily for example to the extruder for pelletization. Furthermore, the polymer powder particles show less fines and a uniform particle size distribution. Next to that, the catalyst system shows a high productivity. This means that the catalyst residues in the polymer are very low.

A suitable way of improving the flowability and reduced fine is by reducing the average particle size distribution of the catalyst system which in turn reduces the average particle size distribution of the resultant polymer powder.

Another advantage of the catalyst system is that the synthesis to produce the catalyst system is relatively simple and cheap and based on readily available and relatively easy to handle compounds.

Further, the inventors surprisingly found that when the hydrocarbon solution and the organo aluminium halide I)b) is simultaneously introduced in the reactor as opposed to sequentially introducing, the resultant catalyst system contains catalyst particles having the desired span or average particle size distribution (PSD). Accordingly, the morphology and size catalyst particles contained in the catalyst system appears to be influenced by the manner in which the catalyst system is prepared.

Accordingly when such a catalyst system is used for the production of polyethylene, the resultant polyethylene has good powder morphology and flowability.

The expression, “introducing the hydrocarbon solution and the organo aluminium halide simultaneously into a reactor”, means that both the components once prepared separately are directly combined while introducing them in the reactor.

Preferably, the catalyst system comprises:
I) the reaction product obtained by reacting preferably in a reactor vessel
   a) the hydrocarbon solution comprising:
      i) the magnesium-containing compound selected from an organic oxygen-containing magnesium compound and/or a halogen-containing magnesium compound; and
      ii) the organic oxygen-containing titanium compound
      wherein the molar ratio of magnesium:titanium is lower than 3:1;
      and
   b) the organo aluminium halide having the formula AlRₙX₃₋ₙ in which R is a
   hydrocarbon moiety containing 1-10 carbon atoms, X is a halogen and 0<n<3; wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.5, preferably wherein the hydrocarbon solution and the organo aluminium halide are supplied to the reactor vessel simultaneously.

Preferably, catalyst particles of the catalyst system have a mean particle diameter D₅₀ in the range of 3.5 to 12.50 μm, preferably in the range of 4.50 to 10 μm, more preferably in the range of 4.50 to 8 μm.

Preferably, the catalyst system comprises:
I) the reaction product obtained by reacting, preferably in a reactor vessel
   a) the hydrocarbon solution comprising:
      i) the magnesium-containing compound selected from an organic oxygen-containing magnesium compound and/or a halogen-containing magnesium compound; and
      ii) the organic oxygen-containing titanium compound wherein the molar ratio of magnesium:titanium is lower than 3:1;
      and
   b) the organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.5 and
wherein the catalyst particles of the catalyst system have a mean particle diameter D₅₀ in the range of 3.5 to 12.50 μm, preferably in the range of 3.50 to 10 μm, more preferably in the range of 4.50 to 8 μm, preferably wherein the hydrocarbon solution and the organo aluminium halide are supplied to the reactor vessel simultaneously.

Preferably, the catalyst system comprises:
I) the reaction product obtained by reacting, preferably in a reactor vessel
   a) a hydrocarbon solution comprising:
      i) a magnesium-containing compound selected from an organic oxygen-containing magnesium compound and/or a halogen-containing magnesium compound; and
      ii) an organic oxygen-containing titanium compound
      wherein the molar ratio of magnesium:titanium is lower than 3:1;
      and
   b) an organo aluminium halide having the formula AlRₙX₃₋ₙ in which R is a hydrocarbon moiety containing 1-10 carbon atoms, X is a halogen and 0<n<3;
wherein the molar ratio of the supplied organo aluminium halide I)b) to supplied titanium in I)a) in the preparation of I) is in the range of 4 to 12, preferably 5-10, more preferably 5-9, most preferably 6-9; and
wherein the average particle size distribution of the catalyst particles is in a range of 0.8 to 1.6, preferably wherein the hydrocarbon solution and the organo aluminium halide are supplied to the reactor vessel simultaneously.

Preferably, the catalyst system comprises:
I) the reaction product obtained by reacting preferably in a reactor vessel
   a) a hydrocarbon solution comprising:
      i) a magnesium-containing compound selected from an organic oxygen-containing magnesium compound and/or a halogen-containing magnesium compound; and
      ii) an organic oxygen-containing titanium compound wherein the molar ratio of magnesium:titanium is lower than 3:1;
      and
   b) an organo aluminium halide having the formula AlRₙX₃₋ₙ in which R is a
hydrocarbon moiety containing 1-10 carbon atoms, X is a halogen and 0<n<3; wherein the molar ratio of supplied organo aluminium halide I)b) to supplied titanium in I)a) in the preparation of I) is in the range of 4 to 12, preferably 5-10, more preferably 5-9, most preferably 6-9 and wherein the average particle size distribution of the catalyst particles is in a range of 0.8 to 1.5, preferably wherein the hydrocarbon solution and the organo aluminium halide are supplied to the reactor vessel simultaneously.

The organic oxygen-containing magnesium compound may for example be selected from magnesium alkoxides such as magnesium methylate, magnesium ethylate and magnesium isopropylate, magnesium alkylalkoxides such as magnesium ethylethylate, and carbonized magnesium alkoxides such as magnesium ethyl carbonate.

For example, the organic oxygen-containing magnesium compound may be a magnesium alkoxide. For example, the magnesium alkoxide may be magnesium ethoxide (Mg(OC₂H₅)₂).

The halogen-containing magnesium compound may for example be selected from magnesium dihalides and magnesium dihalide complexes. For example, the halide in said magnesium dihalides and magnesium dihalide complexes may be chlorine.

The molar ratio of magnesium:titanium is lower than 3:1. Preferably the molar ratio of magnesium:titanium ranges between 1.5:1 and 3:1.

Preferably, the catalyst system comprises:
I) the reaction product obtained by reacting, preferably in a reactor vessel
   a) a hydrocarbon solution comprising:
      i) a magnesium-containing compound selected from an organic oxygen-containing magnesium compound, preferably magnesium ethoxide (Mg(OC₂H₅)₂);
      and
      ii) an organic oxygen-containing titanium compound
      wherein the molar ratio of magnesium:titanium is lower than 3:1;
      and
   b) an organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.6, preferably wherein the hydrocarbon solution and the organo aluminium halide are supplied to the reactor vessel simultaneously.

The organic oxygen-containing titanium compound may for example be represented by the formula [TiOₓ(OR)₄₋₂ₓ]ₙ, wherein R represents an organic radical and 0≤x≤1 and 1≤n≤6.

Preferably, the catalyst system comprises:
I) the reaction product obtained by reacting preferably in a reactor vessel
   a) a hydrocarbon solution comprising:
      i) a magnesium-containing compound selected from an organic oxygen-containing magnesium compound and/or a halogen-containing magnesium compound; and
      ii) an organic oxygen-containing titanium compound be represented by the formula [TiOₓ(OR)₄₋₂ₓ]ₙ, wherein
      R represents an organic radical
      0≤x≤1
      1≤n≤6
         wherein the molar ratio of magnesium:titanium is lower than 3:1;
         and
   b) an organo aluminium halide having the formula AlRnX3-n in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.5, preferably wherein the hydrocarbon solution and the organo aluminium halide are supplied to the reactor vessel simultaneously.

The organic oxygen-containing titanium compound may for example be selected from titanium alkoxides, titanium phenoxides, titanium oxyalkoxides, condensed titanium alkoxides, titanium carboxylates and titanium enolates.

Preferably, the oxygen-containing titanium compound is selected from titanium alkoxides.

The titanium alkoxide may for example be selected from Ti(OC₂H₅)₄, Ti(OC₃H₇)₄, Ti(OC₄H₉)₄ and Ti(OC₈H₁₇)₄. Preferably, the titanium alkoxide is Ti(On-C₄H₉)₄.

Preferably, the catalyst system comprises:
I) the reaction product obtained by reacting preferably in a reactor vessel
   a) a hydrocarbon solution comprising:
      i) a magnesium-containing compound selected from an organic oxygen-containing magnesium compound being magnesium ethoxide (Mg(OC₂H₅)₂); and
      ii) an organic oxygen-containing titanium compound being Ti(On-C₄H₉)₄,
      wherein the molar ratio of magnesium:titanium is lower than 3:1;
      and
   b) an organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.6, preferably wherein the hydrocarbon solution and the organo aluminium halide are supplied to the reactor vessel simultaneously.

The organo aluminium halide I)b) may for example be a compound having the formula an AlRₙX₃₋ₙ wherein R is a hydrocarbon moiety containing 1-10 carbon atoms, X is a halogen and 0<n<3; preferably 1.5<n<3.

The organo aluminium halide I)b) may for example be selected from ethyl aluminium dibromide, ethyl aluminium dichloride, propyl aluminium dichloride, n-butyl aluminium dichloride, isobutyl aluminium dichloride, diethyl aluminium chloride and diisobutyl aluminium chloride. Preferably, X is chlorine. Preferably, the organo aluminium halide I)b) is an organo aluminium chloride. Most preferably, the organo aluminium halide I)b) is ethyl aluminium dichloride.

Preferably, the catalyst system comprises:
I) the reaction product obtained by reacting, preferably in a reactor vessel,
   a) a hydrocarbon solution comprising:
      i) a magnesium-containing compound selected from an organic oxygen-containing magnesium compound being magnesium ethoxide (Mg(OC₂H₅)₂); and
      ii) an organic oxygen-containing titanium compound being Ti(On-C₄H₉)₄,
      wherein the molar ratio of magnesium:titanium is lower than 3:1;
      and
   b) an organo aluminium halide being ethyl aluminium dichloride;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.6, preferably wherein the hydrocarbon solution and the organo aluminium halide are supplied to the reactor vessel simultaneously.

Preferably, the catalyst system for the production of polyethylene is obtained by or obtainable by the process comprising the steps of:
a) providing the hydrocarbon solution comprising:
   i) the magnesium-containing compound selected from an organic oxygen-containing magnesium compound; and
   ii) the organic oxygen-containing titanium compound I)a);
wherein the molar ratio of magnesium:titanium is lower than 3:1;
b) providing the organo aluminium halide I)b) having the formula AlRₙX₃₋ₙ in which R is a hydrocarbon moiety containing 1-10 carbon atoms, ‘X’ is a halogen and 0<n <3;
c) introducing the hydrocarbon solution and the organo aluminium halide simultaneously into a reactor vessel; and
d) obtaining the catalyst system comprising the reaction product (I) obtained by the reaction of the hydrocarbon solution and the organo aluminium halide;
   wherein the molar ratio of supplied organo aluminium halide (Ib) to supplied titanium I)a) is in the range of 1 to 12; and
   wherein the average particle size distribution (PSD) of the catalyst particles contained in the catalyst system is in the range of 0.8 to 1.6 and wherein PSD is defined as PSD=(D₉₀−D₁₀)/D₅₀ and D₁₀, D₉₀ and D₅₀ are measured by laser diffraction as described in this description; and
   wherein the magnesium compound is a magnesium alkoxide, preferably the magnesium alkoxide is magnesium ethoxide Mg(OC₂H₅)₂; and
   wherein the organic oxygen containing titanium compound is represented by the general formula [TiOₓ (OR)₄₋₂ₓ]ₙ in which R represents an organic radical, x ranges between 0 and 1 and n ranges between 1 and 6, preferably wherein the organic oxygen containing titanium compound is selected from alkoxides, phenoxides, oxyalkoxides, condensed alkoxides, carboxylates and/or enolates, preferably the organic oxygen containing titanium compound is alkoxide.

Preferably, the catalyst system for the production of polyethylene is obtained by or obtainable by the process comprising the steps of:
a) providing the hydrocarbon solution comprising:
   i) the magnesium-containing compound, wherein the magnesium-containing compound is magnesium ethoxide Mg(OC₂H₅)₂; and
   ii) the organic oxygen-containing titanium compound I)a), wherein the organic oxygen-containing titanium compound I)a) is Ti(On-C₄H₉)₄,;
wherein the molar ratio of magnesium:titanium is lower than 3:1;
b) providing the organo aluminium halide I)b) having the formula AlRₙX₃₋ₙ in which R is a hydrocarbon moiety containing 1-10 carbon atoms, ‘X’ is a halogen and 0<n <3, wherein the organo aluminium halide I)b) is ethyl aluminium dichloride;
c) introducing the hydrocarbon solution and the ethyl aluminium dichloride simultaneously into the reactor vessel; and
d) obtaining the catalyst system comprising the reaction product of the hydrocarbon solution and the ethyl aluminium dichloride;
   wherein the molar ratio of ethyl aluminium dichloride to Ti(On-C₄H₉)₄ is in the range of 1 to 12; and
   wherein the average particle size distribution (PSD) of the catalyst particles contained in the catalyst system is in the range of 0.8 to 1.6 and wherein PSD is defined as PSD=(D₉₀−D₁₀)/D₅₀ and D₁₀, D₉₀ and D₅₀ are measured by laser diffraction as described in this description.

The aluminium compound having the formula AlR₃ functions for example as a cocatalyst. R₃ may be a hydrocarbon group, preferably an alkyl group having 1-20 carbon atoms, preferably 1-10 carbon atoms.

The aluminium compound having the formula AlR₃ may for example be selected from triethyl aluminium, triisobutyl aluminium, tri-n-hexyl aluminium and trioctyl aluminium. For example, the aluminium compound having the formula AlR₃ may be triethyl aluminium or triisobutyl aluminium.

Preferably, the catalyst system comprises:
I) the reaction product obtained by reacting,
   a) a hydrocarbon solution comprising:
      i) a magnesium-containing compound selected from an organic oxygen-containing magnesium compound being magnesium ethoxide (Mg(OC₂H₅)₂); and
      ii) an organic oxygen-containing titanium compound being Ti(On-C₄H₉)₄, wherein the molar ratio of magnesium:titanium is lower than 3:1;
      and
   b) an organo aluminium halide being ethyl aluminium dichloride;
wherein the molar ratio of supplied organo aluminium halide I)b) to supplied titanium in I)a) in the preparation of I) is in the range of 1 to 12; and
wherein the average particle size distribution of the catalyst particles is in a range of 0.8 to 1.6.

The catalyst system may be prepared by a process comprising the steps of
a) providing a hydrocarbon solution comprising:
   i) a magnesium-containing compound selected from an organic oxygen-containing magnesium compound; and/or a halogen-containing magnesium compound; and
   ii) an organic oxygen-containing titanium compound I)a);
wherein the molar ratio of magnesium:titanium is lower than 3:1;
b) providing an organo aluminium halide I)b) having the formula AlRₙX₃₋ₙ in which R is a hydrocarbon moiety containing 1-10 carbon atoms, X is a halogen and 0<n<3;
c) introducing the hydrocarbon solution and the organo aluminium halide simultaneously into a reactor vessel; and
d) obtaining the catalyst system comprising a reaction product (I) obtained by the reaction of the hydrocarbon solution and the organo aluminium halide

In particular, the catalyst system is prepared by the following steps
1) by providing a solution a) and b)

Solution a) is a hydrocarbon solution comprising:
i) a magnesium-containing compound selected from an organic oxygen-containing magnesium compound and/or a halogen-containing magnesium compound; and
ii) an organic oxygen-containing titanium compound
wherein the molar ratio of magnesium:titanium is lower than 3:1; Solution b) is a hydrocarbon solution comprising an organo aluminium halide having the formula AlRnX3-n in which R is a hydrocarbon moiety containing 1-10 carbon atoms, X is a halogen and 0<n<3.
2) Dosing solution a) and solution b) simultaneously to a receiving means, for example a reactor, such that the molar ratio of supplied organo aluminium halide of b) to supplied titanium of a) is during dosing in the selected range of 1 to 12. For example, the selected molar ratio of supplied organo aluminium halide of b) to supplied titanium of a) may be 6. This means that the molar ratio is kept contstant during dosing of solution a) and b) such that the molar ratio of supplied organo aluminium halide of b) to supplied titanium of a) in the receiving means is at any time 6.
3) removing unreacted reagent like soluble Ti- and Al- species from the catalyst slurry. Soluble contaminants can be removed by filtration or decantation of the catalyst slurry.

For decantation of the catalyst, it is desired that the catalyst shows a good sedimentation behavior. A slow sedimentation behavior would increase the time to perform a decantation step, thus increasing the time to prepare a catalyst batch. Thus it is evident that it is desirable to reduce the sedimentation time during catalyst production. The catalyst system according to the invention shows a sedimentation behavior that is much improved compared to conventional precipitation methods.

Polyethylenes, in particular high density polyethylenes (HDPE) constitute a class of materials which have a balance of material properties that are particularly desirable for a range of applications, in particular for pipes and tubes produced via extrusion moulding processes. For example, high density polyethylenes may have a unimodal molecular weight distribution or a multimodal molecular weight distribution. Such unimodal molecular weight distribution or multimodal molecular weight distribution results in a particular balance of material properties.

Said multimodal molecular weight distribution may be achieved by employing for example two or more polymerization reactors in cascade in the process for production of multimodal HDPE, further referred to as multi-stage polymerization processes. Such multi-stage polymerization processes are described in for example “PE 100 Pipe Systems”, Bromstrup (ed), Vulkan Verlag, 2004, p. 16-20.

The process for the production of polyethylene according to the invention comprises the step of polymerizing ethylene in the presence of the catalyst system according to the invention.

Preferably in an aspect of the invention, the invention relates to a process for the production of polyethylene comprising the step of polymerizing ethylene in the presence of the catalyst system according to the invention and in the presence of a cocatalyst of the formula AlR₃, where R3 is a hydrocarbon group, preferably an alkyl group having 1-20 carbon atoms, preferably 1-10 carbon atoms.

The polymerization process for production of polyethylenes may for example comprise a single polymerization stage. Alternatively, the process for production of polyethylenes may for example comprise multiple polymerization stages, in which the process comprises at least one slurry polymerization process. Said process for the production of polyethylenes comprising multiple polymerization stages is also referred to as a multi-stage polymerization process.

The process for production of polyethylenes is preferably a multi-stage polymerization process comprising at least two stages.

Each individual stage of said multi-stage polymerization process may comprise a separate polymerization reactor, which are set up in cascade so as together to form said multi-stage polymerization process. The operating conditions of each polymerization reactor may different or may be the same as in the other polymerization reactors in cascade together forming said multi-stage polymerization process.

The process for production of polyethylenes may for example be a slurry polymerization process at low temperature and low pressure. The slurry that is used in the slurry polymerization process is defined as a liquid system comprising a diluent as liquid phase, feed monomers, the catalyst system and the polymer particles formed in the course of the polymerization.

As diluent, a hydrocarbon is used that is not reactive under the conditions occurring in the polymerization process, and which is in a liquid phase under the conditions occurring in the polymerization process. The diluent may for example be hexane. Low pressure polymerization is defined as polymerization at partial pressures of ethylene in the range between for example 0.3 MPa and 5.0 MPa, alternatively between for example 0.5 MPa and 3.0 MPa, alternatively between for example 0.5 and 2.0 MPa. Low temperature polymerization is defined as polymerization at temperatures in the range between for example 70° C. and 90° C.

The process for the production of polyethylene may comprise at least one stage comprising a slurry process.

The process for the production of polyethylene may be a multistage polymerization process wherein ingredient I) of the catalyst system is introduced in the first stage of said multi-stage polymerization process.

The catalyst system according to the invention is sufficiently sensitive to hydrogen, to be used in a multi-stage polymerization process for the production of multimodal HDPE. Furthermore, the catalyst system according to the invention is able to produce a low molecular weight polymer fraction according to the desired characteristics of molecular weight distribution, and also to produce a high molecular weight copolymer fraction.

The process for the production of polyethylene using the catalyst system according to the invention may result in polyethylene having a density of ≥935 kg/m³ and ≤975 kg/m³ as measured in accordance with ISO 1183-1 (2012), method A.

Preferably, the process for the production of polyethylene using the catalyst system according to the invention is a multistage process resulting in polyethylene that is a multimodal polyethylene.

The weight fraction of the polyethylene produced in the first stage of said multi-stage slurry polymerization process compared to the total weight of the polymer produced may be for example greater than 20.0 wt %, alternatively greater than 30.0 wt %, alternatively greater than 40.0 wt %.

The weight fraction of the polyethylene produced in the first stage of said multi-stage slurry polymerization process compared to the total weight of the polymer produced may be for example less than 80.0 wt %, alternatively less than 70.0 wt %, alternatively less than 60 wt %.

The weight fraction of the polyethylene produced in the first stage of said multi-stage slurry polymerization process compared to the total weight of the polymer produced may be for example between 40.0 wt % and 60.0 wt % of the total product, alternatively between 47 wt % and 58 wt %.

The polymerization may for example be carried out in the presence of one or more anti-fouling agents. For example, up to 500 ppm of weight of anti-fouling agents may be used, related to the total amount of reactor contents.

The polymerization may be carried out in the presence of one or more anti-static agents. For example, up to 500 ppm of said one or more anti-static agents used, related to the total amount of reactor contents.

The polyethylenes according to the present invention may be unimodal or multimodal polyethylenes. Unimodal polyethylenes in the context of the present invention are defined as polyethylenes having a unimodal molecular weight distribution. Multimodal polyethylenes in the context of the present invention are defined as polyethylenes having a multimodal molecular weight distribution. The molecular weight distribution is defined as the relation between the molecular weight of a polymer molecule present in a polymer sample and the number of molecules in said polymer sample having said molecular weight. Said multimodal molecular weight distribution reflects the combination of the molecular weight distributions of the polyethylenes prepared in each stage of said multi-stage polymerization process.

The molecular weight distribution of polyethylenes according to the present invention may be determined via Size Exclusion Chromatography such as presented in “Handbook of Polyethylene, structure, properties and applications”, A. Peacock, Dekker, New York, 2000, pages 242-244.

Production of polyethylenes in slurry polymerization processes in general takes place in the presence of a catalyst system. Such catalyst systems may for example comprise a catalyst, a cocatalyst and an electron donor.

In the context of the present invention, polyethylenes are to be understood to be the polymer products obtained as output of the polymerization process.

Polyethylenes are described in ‘Olefin Polymers, Introduction’, Y. Kissin, in: Kirk-Othmer Encyclopedia of Chemical Technology, Wiley, 2005 (DOI: 10.1002/0471238961.0914201811091919.a01.pub2).

In polyethylene production processes, the process and the catalyst have to form a well-balanced system in order to arrive at products of the desired characteristics whilst allowing for an efficiently operating process.

The polyethylene obtained or obtainable by the catalyst system according to the invention or by the process according to the invention comprises polyethylene powder particles having an average particle size distribution in the range of 0.70-1.40.

The polyethylene obtained or obtainable by the process according to the invention comprises polyethylene powder particles having an average particle size distribution in the range of 0.70-1.40.

The polyethylene obtained or obtainable by the catalyst system according to the invention or by the process according to the invention comprises polyethylene powder particles having a dry flow in the range from 15-36 s.

The polyethylene obtained or obtainable by the process according to the invention comprises polyethylene powder particles having a dry flow in the range from 15-36 s.

The polyethylene obtained or obtainable by the catalyst system according to the invention or by the process according to the invention comprises polyethylene powder particles having an average particle size distribution in the range of 0.70-1.40 and a dry flow in the range from 15-36 s.

The polyethylene obtained or obtainable by the process according to the invention comprises polyethylene powder particles having an average particle size distribution in the range of 0.70-1.40 and a dry flow in the range from 15-36 s.

The polyethylenes according to the present invention may for example be high density polyethylenes, further referred to as HDPE. The polyethylenes may for example be polyethylene's having a density as measured in accordance with ISO 1183-1 (2012), method A of ≥935 kg/m³, alternatively for example ≥940 kg/m³. The polyethylenes may for example be polyethylenes having a density of ≤975 kg/m³, alternatively for example ≤970 kg/m³, alternatively for example ≤965 kg/m³.

The polyethylenes may for example be polyethylenes having a density in the range of ≥935 kg/m³ and ≤975 kg/m³, alternatively for example in the range of ≥940 kg/m³ and ≤970 kg/m³, alternatively for example in the range of ≥940 kg/m³ and ≤965 kg/m³.

The polyethylenes according to the present invention may for example be multimodal HDPE.

Multimodal HDPE may for example be used for processing into objects via blow moulding, extrusion moulding or injection moulding. Multimodal HDPE may for example be used to produce films, pipes, tubes, and pipe fittings. Examples of multimodal HDPE pipes are pipes for drinking water, sewage, irrigation, natural gas transportation and cable conduits.

Multimodal HDPE is particularly suitable for processing into pipes and tubes by extrusion moulding. Extrusion moulding in the context of the present invention is defined as a process for shaping of thermoplastic materials, such as polyethylenes, including the steps of providing the thermoplastic material in a mouldable state to a die opening, extruding the thermoplastic material through said die opening and cooling the extruded material to below its softening temperature. Thermoplastic materials in the context of the present invention are defined as materials that obtain a mouldable state when heated to above a softening temperature, and that return to a solid state upon cooling to below said softening temperature.

Mouldable state in the context of the present invention is defined as a state in which a material can be formed into the desired shape whilst retaining said desired shape upon leaving the mould used to form said desired shape. In extrusion moulding, said die opening functions as said mould. An important material parameter of polyethylenes is the melt mass flow rate as determined in accordance with ISO 1133-1 (2011), at a temperature of 190° C. and a load of 5.0 kg, further referred to as MFR(5).

The MFR(5) of the multimodal polyethylenes may for example be s 100 g/10 min, alternatively ≤50.0 g/10 min, alternatively ≤25.0 g/10 min, alternatively ≤10.0 g/10 min, alternatively ≤5.00 g/10 min, alternatively ≤4.00 g/10 min, alternatively ≤3.00 g/10 min, alternatively ≤2.00 g/10 min, alternatively ≤1.00 g/10 min.

The MFR(5) of the multimodal polyethylenes may for example be ≥0.01 g/10 min, alternatively ≥0.05 g/10 min, alternatively ≥0.10 g/10 min, alternatively ≥0.15 g/10 min. For example, the MFR(5) of the multimodal polyethylenes according to the present invention may for example be ≥0.05 g/10 min and ≤10.0 g/10 min, alternatively for example ≥0.10 g/10 min and ≤5.00 g/10 min, alternatively for example ≥0.15 g/10 min and ≤2.00 g/10 min.

Another important material parameter of polyethylenes is the melt mass flow rate as determined in accordance with ISO 1133-1 (2011), at a temperature of 190° C. and a load of 21.6 kg, further referred to as MFR(21.6).

The MFR(21.6) of the multimodal polyethylenes according to the present invention may for example be ≤500 g/10 min, alternatively ≤200 g/10 min, alternatively ≤100 g/10 min, alternatively ≤50.0 g/10 min, alternatively ≤20.0 g/10 min.

The MFR(21.6) of the multimodal polyethylenes according to the present invention may for example be ≥0.50 g/10 min, alternatively ≥1.00 g/10 min, alternatively ≥2.00 g/10 min, alternatively ≥5.00 g/10 min, alternatively ≥10.0 g/10 min. For example, the MFR(21.6) of the multimodal polyethylenes according to the present invention may for example be ≥0.50 g/10 min and ≤200 g/10 min, alternatively for example ≥1.00 g/10 min and ≤100 g/10 min, alternatively for example ≥1.00 g/10 min and ≤50.0 g/10 min.

The invention will now be illustrated by the following non-limiting examples.

### Examples

### Measurement Methods

The melt-index MFR 21.6 or melt flow index (MFI) was measured according to method IS01133 under a load of 21.6 kg at 190° C.
The density of the polymers is measured according to IS01183
Bulk density measurement is performed according to DIN ISO 60:2000-01
Pourability of plastic materials are performed according to ASTM D1895-96
The catalyst particle size is measured using laser diffraction. This was done by using a Mastersizer 3000 instrument equipped with a modified Hydro MV unit for automated wet dispersion of samples under an inert atmosphere. The catalyst particle size is calculated with the Mie theory using absorption coefficient=1, refractive index of the catalyst is 1.596 and the refractive index of the dispersant=1.39.
The polymer particle size is measured using laser diffraction. This was done by using a Mastersizer 3000 instrument equipped with an Aero S unit for dry powder dispersion of samples. The catalyst particle size is calculated with the Fraunhofer theory.
The Average Particle Size Distribution (PSD) is calculated according to the following formula PSD=(D90−D10)/D50 with D90 the percentile value that indicate the size below which 90% of all particles are found. D10 is the percentile value that indicate the size below which 10% of all particles are found. D50 is the percentile value that indicate the size below which 50% of all particles are found. D50 is also called the median particle diameter or median particle size. These values can be directly determined from the cumulative particle size distribution.
Image analysis is performed on a Malvern Morphology G3SE with a Nikon CFI Brightfield/Darkfield inspection microscope (Eclips L200ND) and a Baumer 5 M pixels CCD digital color camera. A aliquot of the polyethylene powder of 19-38 mm³ was dry dispersed in air with aid of the Solid Dispersion Unit (SDU) on an object of glass with the following settings: an air pulse of 1 bar during 20 miliseconds and a settling time of 600 seconds. A magnification of 5× is used. To achieve an accurate focus across the entire body of small and large three-dimensional particles, up to 5 images at different focal points are taken of a particle and then merged to provide a single composed image.

### Catalyst Preparation

### A) Preparation of Precursor (A), (Preparation of Solution I)

Under a nitrogen atmosphere, 132.5 g of granular Mg(OC₂H₅)₂ and 199 ml of Ti(On-C₄H₉)₄, both at a temperature of 25° C. were introduced into a 2 L round bottom flask equipped with a reflux condenser and a stirrer. Under gentle stirring, the mixture was heated to 180° C. and subsequently stirred for 90 min. A clear liquid was obtained. The contents of the round bottom flask were cooled to 120° C., and subsequently diluted with 1318 g hexane. The contents of the round bottom flask were cooled to 67° C. The temperature was maintained at 67° C. for 120 min, and subsequently cooled down to 25° C. The resulting solution was stored under nitrogen atmosphere. A solution with a Ti concentration of 1.82 wt % was obtained.

B1) Preparation of Inventive Catalyst 1, Inv. Cat. 1 (Prepared Usigq Simultaneous Addition of 20 Solution I and Solution I to a Glass Reactor Vessel)

All equipment and glassware was dried and kept under inert conditions during synthesis. 305 mL hexane was introduced into a 1.0 L glass reactor equipped with baffles, a reflux condenser and a stirrer.

### Solution I (The Hydrocarbon Solution)

157 mL of precursor A was added to a Schlenk flask using a graduated pipet.

### Solution II (The Organo Aluminium Halide)

In a separate Schlenk flask, 75 mL of a 50 wt % solution of ethyl aluminium dichloride (EADC) in hexane was added to 82 mL hexane.

Peristaltic pumps were installed to connect both Schlenk flasks to the 1.0 L glass reactor.

The contents of the Schlenk flasks (Solution I and Solution II) were then drop wise simultaneously transferred to the reactor using the following peristaltic pump and reactor settings. Solution I and II were introduced simultaneously into the glass reactor gradually over a period of 18 min using a peristaltic pump. The addition of Solution I and II being done simultaneously was a key aspect in the procedure.
Reactor Temperature=25° C.
Reactor Stirrer Speed=1400 RPM
Peristaltic Pump Speed=18 RPM (calibrated to transfer 157 mL of solution II in 18 min)
Peristaltic Pump Speed=18 RPM (calibrated to transfer 157 mL of Solution I in 18 min)

After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.

B2) Preparation of Inventive Catalyst 2, Inv. Cat 2 (Prepared Using Simultaneous Addition of Solution I and Solution II to a Glass Reactor Vessel)

All equipment and glassware was dried and kept under inert conditions during synthesis. 371 mL hexane was introduced into a 1.0 L glass reactor equipped with baffles, a reflux condenser and a stirrer.

### Solution I (The Hydrocarbon Solution)

124 mL of precursor A was added to a Schlenk flask using a graduated pipet.

### Solution II (The Organo Aluminium Halide)

In a separate Schlenk flask, 59 mL of a 50 wt % solution of ethyl aluminium dichloride (EADC) in hexane was added to 65 mL hexane.

Peristaltic pumps were installed to connect both Schlenk flasks. The contents of the Schlenk flasks were then drop wise simultaneously transferred to the reactor using the following peristaltic pump and reactor settings. Solution I and II were introduced simultaneously into the glass reactor gradually over a period of 19 min using a peristaltic pump. The addition of Solution I and ∥ being done simultaneously was a key aspect in the procedure.
Reactor Temperature=25° C.
Reactor Stirrer Speed=1400 RPM
Peristaltic Pump Speed=16 RPM (calibrated to transfer 124 mL of solution II in 19 min)
Peristaltic Pump Speed=16 RPM (calibrated ot transfer 124 mL of solution I in 19 min)

After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.

B3) Preparation of Inventive Catalyst 3, Inv. Cat 3 (Prepared Using Simultaneous Addition of Solution I and Solution I to a Glass Reactor Vessel)

All equipment and glassware was dried and kept under inert conditions during synthesis.

380 mL hexane was introduced into a 1.0 L glass reactor equipped with baffles, a reflux condenser and a stirrer.

### Solution I (The Hydrocarbon Solution)

124 mL of precursor A was added to a Schlenk flask using a graduated pipet.

### Solution II (The Organo Aluminium Halide)

In a separate Schlenk flask, 42 mL of a 50 wt % solution of ethyl aluminium dichloride (EADC) in hexane was added to 23 mL hexane.

Peristaltic pumps were installed to connect both Schlenk flasks. The contents of the Schlenk flasks were then drop wise simultaneously transferred to the reactor using the following peristaltic pump and reactor settings.

Solution I and II were introduced simultaneously into the glass reactor gradually over a period of 18 min using a peristaltic pump. The addition of Solution I and II being done simultaneously was a key aspect in the procedure.
Reactor Temperature=25° C.
Reactor Stirrer Speed=1400 RPM
Peristaltic Pump Speed=31 RPM (calibrated to transfer 124 mL of solution II in 18 min)
Peristaltic Pump Speed=14 RPM (calibrated to transfer 65 mL of solution I in 18 min)

After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.

C1) Preparation of Comparative Catalyst 1, Comp. Cat 1 (Prepared Using Sequential Addition of Solution I to Solution I as Opposed to Simultaneous Addition)

All equipment and glassware was dried and kept under inert conditions during synthesis.

300 mL hexane was introduced into a 1.0 L glass reactor equipped with baffles, a reflux condenser and a stirrer.

### Solution I

157 mL of precursor A was added to the glass reactor using a graduated pipet.

### Solution II

In a separate Schlenk flask, 59 mL of a 50 wt % solution of ethyl aluminium dichloride (EADC) in hexane was added to 42 mL hexane. Solution II was introduced into the glass reactor gradually over a period of 15 min using a peristaltic pump.

A peristaltic pump was installed to connect the schlenk flask with Solution I to the reactor containing Solution I having precursor A.

The contents of the schlenk flask were then drop wise transferred to the reactor using the following peristaltic pump and reactor settings. For the purpose of comparative example, the addition of Solution II was done sequentially into the glass reactor that already contained Solution I.

$$Reactor Temperature = 25 ° C .$$

$$Reactor Stirrer Speed = 1400 RPM$$

Peristaltic Pump Speed=18 RPM (calibrated to transfer 117 mL of EADC in 15 min)

After addition of EADC solution, the tubing of the peristaltic pump was rinsed with 50 mL of hexanes. The temperature of the reactor was set to 71° C. and the mixture was left to reflux for 2 hours. The contents were transferred to a P4 filter and washed with 2 liter of hexanes. The washed catalyst is transferred to a 500 mL round bottom flask and stored in nitrogen cabinet.

TABLE 1
reactor conditions, elemental composition,
and particle size of the catalysts.

| | Inv. | Inv. | Inv. | Comp. |
|---|---|---|---|---|
| | Cat 1 | Cat 2 | Cat 3 | Cat. 1 |
| Al/Ti (mol/mol) | 6 | 6 | 4 | 6 |
| Precursor A (mol/L) | 0.095 | 0.07 | 0.07 | 0.095 |
| Mg [wt %] | 10.3 | 10.9 | 9.8 | 10.5 |
| Al [wt %] | 3.5 | 3.7 | 3.3 | 4.3 |
| Cl [wt %] | 44.8 | 46.9 | 36.0 | 43.0 |
| Ti [wt %] | 9.4 | 9.5 | 8.4 | 8.5 |
| D₅₀ | 11.5 | 6.2 | 10.1 | 5.74 |
| Average particle | 1.19 | 1.08 | 1.57 | 1.81 |
| size distribution | | | | |
| (Span) | | | | |

The catalyst particle of inventive Inv. Cat. 1-3 have a much lower span than the comparative example Comp. Cat. 1

The catalyst system according to the invention (Inv. Cat 1-3) exhibits a reduced sedimentation time which is at least 40% shorter than compared to the comparative example (Comp. Cat. 1).

It appears the method of adding Solution I and Solution I to the glass reactor have a certain degree of influence on the average particle size distribution of the catalyst particles.

### Polymerisation Experiments

### D) Ethylene Homopolymerization

5 L of dry hexane were added to a reactor having an internal volume of 10 L and equipped with a stirrer. Next, a hexane solution of 0.8 mol/L triisobutyl aluminum (TiBAl) was added to the reactor. The contents were heated to the desired polymerization temperature while stirring at 750 RPM. Ethylene and hydrogen were added in a certain ratio of partial pressures (pC₂ respectively pH₂) to reach a desired pressure in the reactor. Next, an aliquot of the catalyst suspension according to one of the above identified catalysts as indicated in the table above (Table 1), containing a previously determined amount of solid catalyst, was added to the reactor the start the polymerization. The total pressure in the reactor was kept constant by dosing ethylene. The hydrogen over ethylene ratio in the headspace of the reactor (H₂/C₂) was continuously monitored by gas chromatography and was kept constant by dosing hydrogen on demand. After polymerization time of 120 minutes, the pressure in the reactor was reduced to ambient conditions and the reactor was flushed with nitrogen. The reactor temperature was cooled to 35° C. and the slurry was subsequently filtered to collect the wet polymer fluff. The polymer was subsequently rinsed with 10 liters of hexanes, collected and dried in an oven at 40° C. under vacuum for 18 hours. The dried polymer was weighed and analyzed on density and melt-flow index (MFR_{19012.16}). The applied settings for the polymerization experiments can be found in table 2.

TABLE 2
Ethylene homopolymerization reactor settings

| | | Catalyst | TiBAl | Temp. | pC₂ | | Yield | MFR_{190/2.16} | Density |
|---|---|---|---|---|---|---|---|---|---|
| Example | | (mg) | (mM) | (° C.) | (bar) | H₂/C₂ | (g) | (dg/min) | (kg/m³) |
| Ex. 1 | Cat. 1 | 40 | 0.8 | 85 | 1.6 | 3.51 | 437 | 269.6 | 970 |
| Ex. 2 | Cat. 2 | 40 | 0.8 | 85 | 1.6 | 3.48 | 487 | 237 | 973 |
| Ex. 3 | Cat. 3 | 100 | 0.8 | 85 | 1.6 | 2.45 | 230 | n.d. | 969 |
| Ex. 4 Comp | Cat. 1 | 40 | 0.8 | 85 | 1.6 | 3.49 | 403 | 264 | 971 |
| | Comp. | | | | | | | | |

TABLE 3
PE powder morphology

| | | | | | | | Average | |
|---|---|---|---|---|---|---|---|---|
| | | | | | | | particle | |
| | | | | | | | size | |
| | | | | | | | distribution | Dry |
| | | MFR_{190/2.16} | Density | D₁₀ | D₅₀ | D₉₀ | (PSD): | flow |
| Example | | (dg/min) | (kg/m³) | (μm) | (μm) | (μm) | Span | (s) |
| Ex. 1 | Cat. 1 | 269.6 | 970 | 162 | 247 | 375 | 0.86 | 19.5 |
| Ex. 2 | Cat. 2 | 237 | 973 | 101 | 150 | 224 | 0.82 | 20.5 |
| Ex. 3 | Cat. 3 | 230 | 969 | 91 | 148 | 236 | 0.98 | n.a. |
| Ex. 4 | Cat. 1 | 264 | 971 | 48 | 113 | 217 | 1.49 | 38.3 |
| Comp | Comp. | | | | | | | |

The PE homopolymerization powder samples made with inventive Inv. Cat. 1-3 have a much lower span than the PE powder samples comparative examples Comp. Cat. 1. The fraction of very fine particles (<105 μm) is lower for Inv. Cat 1-3, as is indicated by D₁₀. Likewise the dry flow is much faster for Cat 1-3. This is means that the PE powders will flow more easily, resulting, for instance improved dosing of polyethylene powder into the extruder.

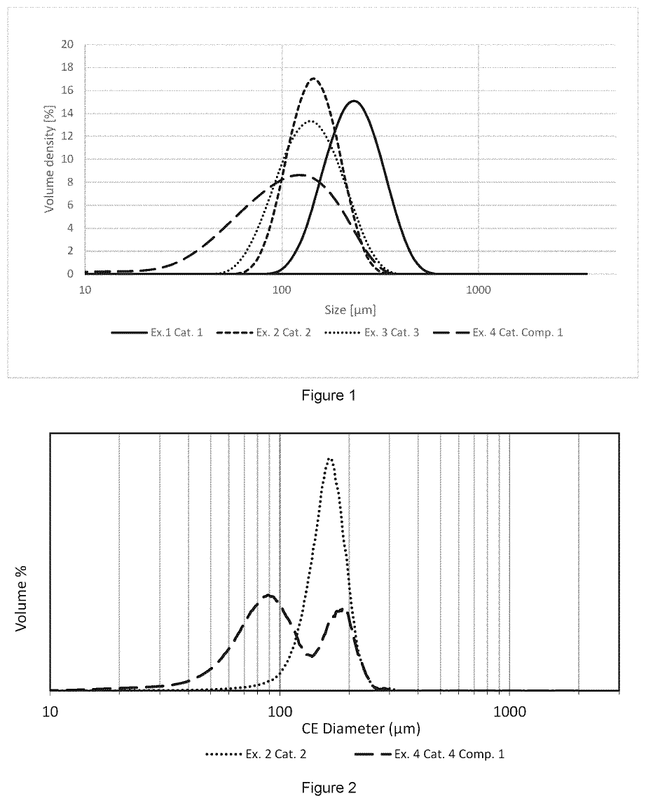

FIG. 1 shows laser diffraction PSD curves of homopolymerization of PE powder from Ex.1-4

FIG. 2 shows an image analysis of Ex. 2 and Ex. 4 Comparative

FIG. 3 shows a representative SEM image of PE powder from Ex. 2. As can be seen, the polymer powder shows no particle sizes <100 μm for Ex. 2 Cat. 2

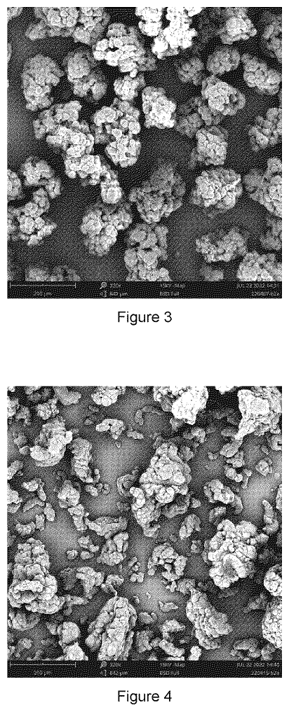

FIG. 4 shows a representative SEM image of PE powder from Ex. 4 Comp. As evidenced by the image, the polymer powder shows significant amount of particles <100 μm Ex. 4 Comp. 1.

### E) Ethylene Copolymerization

The procedure for these experiments were similar to the ethylene homo-polymerization procedure as described above, except for the fact that 1-butene was metered into the reactor directly after hydrogen dosing (before ethylene dosing), before the start of the polymerization. The 1-butene to ethylene molar ratio in the headspace (C₄/C₂) of the reactor was continuously measured by gas chromatography and 1-butene was fed on demand to keep the ratio at the desired value. The applied settings for the polymerization experiments can be found in Table 4.

TABLE 4
Ethylene copolymerization reactor settings

| | | Cat. | TiBAl | Temp. | pC₂ | | | Yield | MFR_{190/5} | Density |
|---|---|---|---|---|---|---|---|---|---|---|
| Example | Cat. | (mg) | (mM) | (° C.) | (bar) | H₂/C₂ | C₄/C₂ | (g) | (dg/min) | (kg/m³) |
| Ex. 6 | Inv. | 20 | 0.8 | 85 | 1.6 | 0.5 | 0.07 | 383 | 9.6 | 943 |
| | Cat. 1 | | | | | | | | | |
| Ex. 7 | Inv. | 20 | 0.8 | 85 | 1.6 | 0.5 | 0.07 | 412 | 6.9 | n.a. |
| | Cat. 2 | | | | | | | | | |
| Ex. 8 | Comp. | 20 | 0.8 | 85 | 1.6 | 0.5 | 0.07 | 322 | 6.6 | 943 |
| Comp | Cat. 1 | | | | | | | | | |

TABLE 5
PE powder morphology

| | | | | | | | Average | |
|---|---|---|---|---|---|---|---|---|
| | | | | | | | particle | |
| | | | | | | | size | |
| | | | | | | | distribution | Dry |
| | | MFR_{190/5} | Density | D₁₀ | D₅₀ | D₉₀ | (PSD): or | flow |
| Example | | (dg/min) | (kg/m³) | (μm) | (μm) | (μm) | Span | (s) |
| Ex. 6 | Inv. Cat. 1 | 9.6 | 943 | n.d. | n.d. | n.d. | n.d. | 17.0 |
| Ex. 7 | Inv. Cat. 2 | 6.9 | n.a. | 115 | 172 | 258 | 0.82 | 35.4 |
| Ex. 8 | Comp. Cat. | 6.6 | 943 | n.m. | n.m. | n.m. | n.m. | 110* |
| Comp | 1 | | | | | | | |

*Powder dry flow of the sample was only achieved by tapping on the dry flow funnel

The PE powder sample made with inventive Inv. Cat. 2 has a much lower span than the PE powder samples made with the comparative examples Comp. Cat. 1. The fraction of very fine particles (<105 μm) is low for Inv. Cat 2, as is indicated by the D₁₀>105 μm. Likewise the dry flow is much faster for Cat 2 compared to Ex. 8 Comp. Where a powder flow could only initiated by tapping on the dry flow funnel.

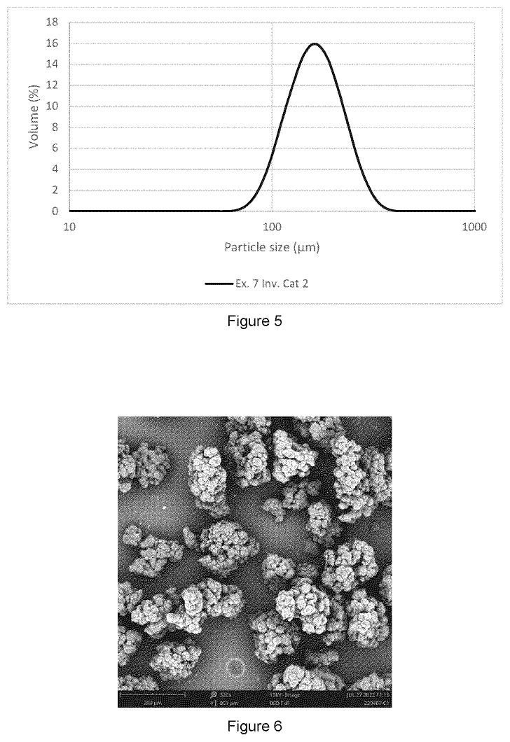

FIG. 5. laser diffraction PSD curve of Ex. 7, Inv. Cat. 2

FIG. 6 shows a SEM image of Ex.7 Cat 2 of the PE copolymer.

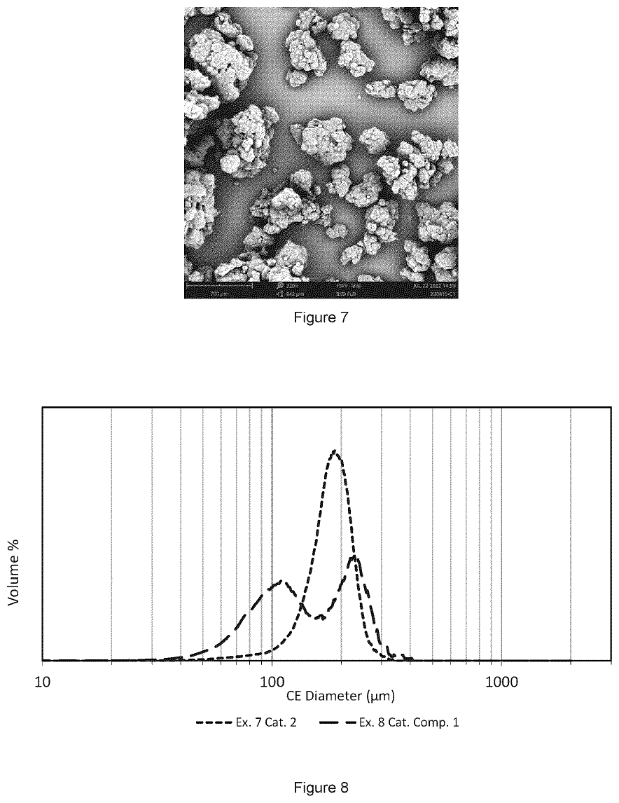

FIG. 7 shows a SEM image of Ex. 8 Cat Comp. 1 of the PE copolymer

FIG. 8 shows light scattering image analysis PSD curves of Ex. 7 and Ex. 8 Comp. of the PE polymer.

From the results it is evident that the Average particle size distribution of the catalyst particles influenced the powder morphology of the polymer powder and in turn its flowability. It was surprisingly found that the method of adding the Solution I(hydrocarbon solution) and Solution II (organo aluminium halide) influenced catalyst particle morphology, which in turn influenced the Average particle size distribution of the polymer powder.

1. A catalyst system for the production of polyethylene comprising:
I) the reaction product obtained by reacting,
a) a hydrocarbon solution comprising:
i) a magnesium-containing compound selected from an organic oxygen-containing magnesium compound and/or a halogen-containing magnesium compound; and
ii) an organic oxygen-containing titanium compound
wherein the molar ratio of magnesium:titanium is lower than 3:1;
and
b) an organo aluminium halide having the formula AlRₙX₃₋ₙ in which R is a hydrocarbon moiety containing 1-10 carbon atoms, X is a halogen and 0<n<3;
wherein the molar ratio of supplied organo aluminium halide I)b) to supplied titanium in I)a) in the preparation of I) is in the range of 1 to 12; and
wherein the average particle size distribution (PSD) of the catalyst particles is in the range of 0.8 to 1.6 and wherein PSD is defined as PSD=D₉₀−D₁₀)/D₅₀ and D₁₀, D₉₀ and D₅₀ are measured by laser diffraction as described in the specification.

2. The catalyst system according to claim 1 wherein the average particle size distribution of the catalyst particles is in a range of 0.8 to 1.5.

3. The catalyst system according to claim 1, wherein the median particle diameter D50 of the catalyst particles is in the range of 3.5 to 12.50 μm, as measured by laser diffraction.

4. The catalyst system according to claim 1, wherein the molar ratio of supplied organo aluminium halide I)b) to supplied titanium in I)a) in the preparation of I) is in the range of 4 to 12.

5. The catalyst system according to claim 1, wherein the magnesium compound is a magnesium alkoxide.

6. The catalyst system according to claim 1 wherein the organic oxygen containing titanium compound is represented by the general formula [TiOₓ(OR)₄₋₂ₓ]ₙ in which R represents an organic radical, x ranges between 0 and 1 and n ranges between 1 and 6.

7. The catalyst system according to claim 6 wherein the organic oxygen containing titanium compound is selected from alkoxides, phenoxides, oxyalkoxides, condensed alkoxides, carboxylates and/or enolates.

8. The catalyst system according to claim 6, wherein the organic oxygen containing titanium compound is a titanium alkoxide.

9. The catalyst system according to claim 1, wherein the organo aluminium halide has the formula AlRₙX₃₋ₙ in which X is chloride.

10. The catalyst system according to claim 9, wherein the organo aluminium halide is ethyl aluminium dichloride (EADC).

11. A process for the production of polyethylene comprising the step of polymerizing ethylene in the presence of the catalyst system according to claim 1 and in the presence of a cocatalyst of the formula AlR₃, where R₃ is a hydrocarbon group.

12. The process for the production of polyethylene according to claim 11 wherein the process is a multi-stage polymerization process comprising at least two stages.

13. The process for the production of polyethylene according to claim 11, wherein at least one stage of the process comprises a slurry process.

14. The process according to claim 11, wherein ingredient I) of the catalyst system is introduced in the first stage of said multi-stage polymerization process.

15. A polyethylene obtained by the process according to claim 11, wherein the polyethylene powder particles have an average particle size distribution in the range of 0.70-1.40; and/or a dry flow in the range from 15-36 s.
